(19) United States
(12) Patent Application Publication
(10) Pub. No.: US 2025/0166021 A1
(43) Pub. Date: May 22, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Yoshihiro YONEDA, Tokyo (JP)

(21) Appl. No.: 18/907,853

(22) Filed: Oct. 7, 2024

(30) Foreign Application Priority Data
Nov. 20, 2023 (JP) 2023-196816

(51) Int. Cl. G06Q 30/0273; G06F 40/20

(52) U.S. Cl. CPC G06Q 30/0275; G06F 40/20

(57) ABSTRACT

An information processing apparatus according to the present application includes a generation unit, a provision unit, and a determination unit. Upon receipt of a question from a user, the generation unit causes candidates for advertisement and the question to be input to generative AI and thereby causes the generative AI to generate answer contents including an advertisement selected from the candidates according to at least one of the user and an answer generated by the generative AI as an answer to the question. The provision unit provides the answer contents that the generative AI was caused to generate by the generation unit, to the user. The determination unit determines cost an advertiser of the advertisement is to be charged, according to operation on the advertisement by the user.

### CROSS-REFERENCE TO RELATED APPLICATIONS

The present application claims priority to and incorporates by reference the entire contents of Japanese Patent Application No. 2023-196816, filed on Nov. 20, 2023.

### BACKGROUND OF THE INVENTION

### 1. Field of the Invention

The present invention relates to an information processing apparatus, an information processing method, and a non-transitory computer readable storage medium.

### 2. Description of the Related Art

Conversion-based billing techniques have been known conventionally for conversions generated via the Internet.
Patent Literature 1: Japanese Unexamined Patent Application Publication No. 2020-177525

However, no orthodox scheme for monetization using generative AI has been established by these conventional techniques and the conventional techniques have not enabled well-suited monetization using generative AI.

### SUMMARY OF THE INVENTION

An information processing apparatus according to the present disclosure includes: a generation unit that causes generative AI to generate answer contents including an advertisement selected from candidates for advertisement according to at least one of a user and an answer that has been generated by the generative AI as an answer to a question by inputting the candidates and the question to the generative AI upon receipt of the question from the user; a provision unit that provides the answer contents that the generative AI was caused to generate by the generation unit, to the user; and a determination unit that determines cost that an advertiser of the advertisement is to be charged, according to operation on the advertisement by the user.

### BRIEF DESCRIPTION OF THE DRAWINGS

FIG. 1 is a diagram illustrating an example of a configuration of an information processing system according to an embodiment;

FIG. 2 is a diagram illustrating an example of information processing according to the embodiment;

FIG. 3 is a diagram illustrating an example of a configuration of a terminal device according to the embodiment;

FIG. 4 is a diagram illustrating an example of a configuration of a generative AI server according to the embodiment;

FIG. 5 is a diagram illustrating an example of a configuration of an information processing apparatus according to the embodiment;

FIG. 6 is a diagram illustrating an example of a user information storage unit according to the embodiment;

FIG. 7 is a diagram illustrating an example of an advertisement information storage unit according to the embodiment;

FIG. 8 is a diagram illustrating an example of a conversion information storage unit according to the embodiment;

FIG. 9 is a flowchart illustrating an example of the information processing according to the embodiment; and

FIG. 10 is a hardware configuration diagram illustrating an example of a computer that implements functions of the information processing apparatus.

### DETAILED DESCRIPTION OF THE PREFERRED EMBODIMENTS

A mode (hereinafter, referred to as “embodiment”) for implementing an information processing apparatus, an information processing method, and an information processing program, according to the present application will hereinafter be described in detail, while reference is made to the drawings. The information processing apparatus, the information processing method, and the information processing program, according to the present application, are not to be limited by this embodiment. With respect to the embodiment, the same signs will be assigned to the same parts and redundant description thereof will be omitted.

### EMBODIMENT

### 1. Configuration of Information Processing System

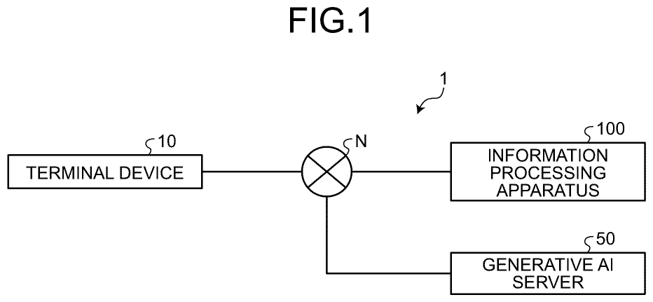

The following description is on an information processing system 1 illustrated in FIG. 1. As illustrated in FIG. 1, the information processing system 1 includes a terminal device 10, a generative AI server 50, and an information processing apparatus 100. The terminal device 10, the generative AI server 50, and the information processing apparatus 100 are communicably connected to one another by wire or wirelessly via a predetermined communication network (a network N). FIG. 1 is a diagram illustrating an example of a configuration of the information processing system 1 according to the embodiment.

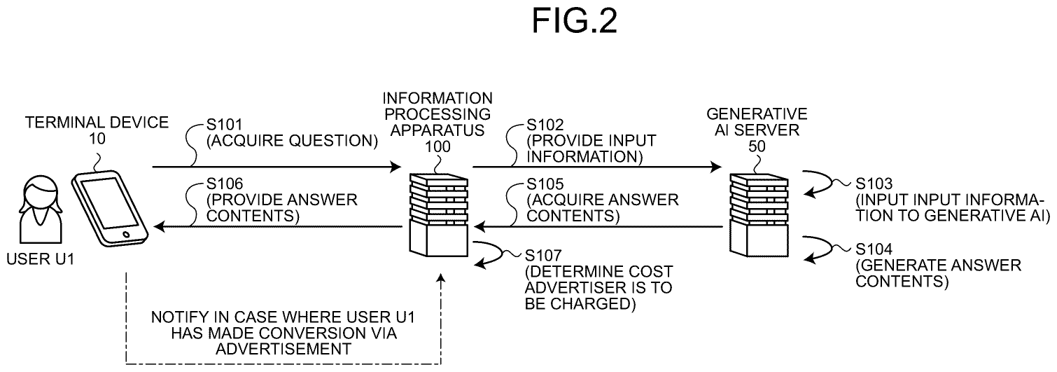

The terminal device 10 is an information processing device used by a user who asks a question. For example, the terminal device 10 is used by a user who asks a question when performing a search and requests an answer useful for the search. The terminal device 10 may be any device that is capable of implementing processing according to the embodiment. For example, the terminal device 10 may be a device, such as a smartphone, a tablet device, a notebook PC, a desktop PC, a mobile phone, or a PDA. FIG. 2 illustrates a case where the terminal device 10 is a smartphone.

The terminal device 10 is, for example, a mobile terminal device that is a smart device, such as a smartphone or a tablet, and that is capable of performing communication with any server apparatus via a wireless communication network of, for example, the fourth or fifth generation (4G or 5G) or Long Term Evolution (LTE). The terminal device 10 has a screen that is, for example, a liquid crystal display and that has a touch panel function, and the terminal device 10 may receive various kinds of operation on display data, such as contents, from a user via the user's finger or a stylus, the various kinds of operation including tapping operation, sliding operation, and scrolling operation. In FIG. 2, the terminal device 10 is used by a user U1.

The generative AI server 50 is an information processing apparatus that controls generative AI (provides a platform of the generative AI) and may be any apparatus that is capable of implementing processing according to the embodiment. By inputting information provided from the information processing apparatus 100, to the generative AI, for example, the generative AI server 50 generates answer contents and provides the answer contents to the information processing apparatus 100. The answer contents include at least an answer to a user, the answer corresponding to a question, and an advertisement (for example, a top advertisement of advertisements listed in predetermined order) selected from candidates determined beforehand as candidates for advertisement to be provided with the answer. The answer contents are information indicating the answer to the user, and the candidate selected from the candidates for advertisement, the answer corresponding to the question, and the answer contents may be not contents that are actually displayed on the terminal device 10. Therefore, the contents actually displayed on the terminal device 10 may be generated by the information processing apparatus 100 on the basis of information related to the answer to the user, the answer corresponding to the question, and information related to the candidate selected from the candidates for advertisement.

The generative AI is, for example, a text generative model that has been trained with data published on the Internet. For example, the generative AI is a generative pre-trained transformer (GPT) model that generates answers to questions. Such a model generates an answer to a question from data published on the Internet. New data are published every day on the Internet and answers generated by the model are thus updated every day. That is, even if the same question is asked, different answers will be generated, because data referred to by the model when the model generates an answer differ depending on the time, at which the question is asked. The model is capable of providing detailed answers to questions in a wide range of areas and is thus asked a wide variety of questions by users.

The information processing apparatus 100 is an information processing apparatus for the purpose of performing well-suited monetization using the generative AI and may be any apparatus that is capable of implementing processing according to the embodiment. Upon receipt of a question from a user, for example, the information processing apparatus 100 provides information (input information to be input to the generative AI) to the generative AI server 50 to generate answer contents including an answer to the user, the answer corresponding to the question. The input information to be input to the generative AI includes, for example, at least text information on the question, advertisement candidate information related to candidates for advertisement, user information related to the user, and a prompt to instruct the generative AI to execute information processing using various kinds of information. For example, the information processing apparatus 100 provides answer contents (output information output from the generative AI) provided from the generative AI server 50, for example, to the user. Furthermore, according to operation by the user on an advertisement (an advertisement included in the answer contents) selected as an advertisement provided with the answer, for example, the information processing apparatus 100 determines cost to be demanded from an advertiser of the advertisement selected (an amount of money the advertiser is to be charged). For example, the cost is cost generated in a case where a conversion is generated by the user clicking on the advertisement. That is, the money that the advertiser is charged is pay for affiliative performance. Furthermore, according to a volume of text of the question (for example, an amount of the text), the information processing apparatus 100 determines cost for use of the generative AI (an amount of money charged by a provider of the generative AI). That is, the money charged by the provider of the generative AI (for example, an administrator of the generative AI server 50) is money charged per volume. Charging may be based on, not necessarily the text of the question, but a volume of all of text including text of the prompt. Therefore, the prompt may be generated to have text shorter in length on the basis of a history selected according to the user.

FIG. 1 illustrates a case where the generative AI server 50 and the information processing apparatus 100 are separate apparatuses, but the generative AI server 50 and the information processing apparatus 100 may be integrated with each other. Therefore, the information processing apparatus 100 may provide the platform of the generative AI.

### 2. Example of Information Processing

For conventional searches using queries, advertisers can be charged on the basis of conversions from advertisements displayed with search results, but for searches using generative AI, no orthodox scheme for monetization has been established and thus no well-suited monetization using generative AI has been achieved. In view of the above, an object according to the present application is to implement well-suited monetization using generative AI.

In a search using a query, for example, display order of search results is determined on the basis of bid prices or user click-through rates. By contrast, in a search using generative AI, rules for determining display order of search results may be determined beforehand and the display order may be determined on the basis of these rules, or the display order may be determined on the basis of training. In this training, for example, data indicating what kinds of people purchased what products may serve as training data. Standard generative AI undergoes supervised training that attaches importance to fairness by use of data available on the Internet, but in a case where data available on a predetermined service can serve as training data, training using data that cannot be known by standard generative AI is able to be performed. Determining the display order on the basis of the training may sometimes be better even if it may result in negative monetization. However, monetization by display in descending order of bid price is also important so such a rule based on bid prices may also be adopted.

The display order may thus be determined using rules for plural ways of outputting search results. In a case where the display order is determined on the basis of the training, an advertisement for a product that a user may be able to buy (or a product that a user may want) is placed in a predetermined frame on a UI screen, for example, and an advertisement frame (sponsor frame) may be provided as a separate frame where an advertisement for a product based on a bid price may be placed. Excessive messages conveyed by advertisement frames on UI screens may give bad impressions in terms of service, but placement of advertisements for products that users may want enables attraction of users who have found value in those products. For example, advertisements related to goods in stock may be placed in relation to electronic commerce (EC), advertisements related to hotel reservations may be placed in relation to fine food, and advertisements related to job offers may be placed in relation to employment. The goods in stock, reservations, and job offers are thereby able to be presented in a well-suited manner to prompt action according to what the users have consulted with the AI about. Furthermore, plural senses of values for surprise, for example, may be presented to a user so that the user is caused to make a selection therefrom and an advertisement for a product corresponding to the selected sense of values may be placed.

Service histories different among plural domains may serve as a user history. In a case where input information is such histories of all of domains in generation of an answer to a user using generative AI, contents matching the user are able to be generated and selected, but the amount of information may be too much, increasing the load. Furthermore, cost for generative AI is calculated according to the amount of text input and thus the larger the amount of information is, the higher the cost becomes. Therefore, the load may be reduced by selection of a history corresponding to a question from histories acquired from plural domains and inputting only the history selected as user information.

FIG. 2 is a diagram illustrating an example of information processing by the information processing system 1 according to the embodiment. When the user U1 asks a question, the information processing apparatus 100 receives the question from the user U1 (Step S101). For example, the information processing apparatus 100 receives the question as text, from the user U1. The information processing apparatus 100 provides information (input information to be input to the generative AI) to the generative AI server 50 for generation of answer contents including an answer to the user U1, the answer corresponding to the question (Step S102). For example, as the input information to the generative AI, the information processing apparatus 100 provides advertisement candidate information related to candidates for advertisement for selection of an advertisement to be provided with the answer to the user U1, text information on the question received from the user U1, user information related to the user U1, and information related to a prompt to instruct the generative AI to execute information processing using various kinds of information. The prompt is text of an instruction to instruct what is to be executed as the information processing using the various kinds of information, and is, for example, text of an instruction, “Please select an advertisement well-suited for the user U1”. By means of such text of an instruction, an advertisement to be included in the answer contents is selected on the basis of the user information on the user U1, the advertisement candidate information, and the text information on the question. Furthermore, for example, by means of text of an instruction, “Please generate an answer to the question including contents of the selected advertisement”, for example, the answer to be included in the answer contents is generated from the user information on the user U1, the advertisement candidate information, and the text information on the question. The prompt may be determined beforehand or may be generated by the information processing apparatus 100. For example, the prompt may be generated according the user information on the user U1, the question received from the user U1, and/or the advertisement candidate information.

Furthermore, the prompt includes text of an instruction to instruct which information of the input information to be input to the generative AI is used to execute the information processing. For example, the prompt may include text of an instruction to instruct whether advertisement candidate information on all of advertisements is to be a target, from which an advertisement is to be selected, or whether the candidates for advertisement are to be narrowed down according to the user information. Furthermore, for example, the prompt includes text of an instruction to instruct what is executed as the information processing using the input information to be input to the generative AI. For example, the prompt may include text of an instruction to instruct how the user information is used to make a selection from the advertisements. The prompt thus includes text of an instruction to instruct which information of the input information to be input to the generative AI is used in what way to execute the information processing.

Upon acquisition of the input information to the generative AI from the information processing apparatus 100, the generative AI server 50 inputs the input information provided from the information processing apparatus 100, to the generative AI (Step S103). The generative AI generates answer contents on the basis of the input information (Step S104). For example, the generative AI generates an answer to the question by the user U1 on the basis of the input information and generates answer contents including the answer generated. Furthermore, for example, the generative AI selects an advertisement on the basis of the input information and generates answer contents including the advertisement selected. For example, the generative AI selects an advertisement on the basis of a history of any domain frequently used by the user U1, the history being from a domain history of the user U1, and generates answer contents including the advertisement selected. For example, the generative AI selects an advertisement on the basis of a history selected according to the question by the user U1, the history being from the domain history of the user U1, and generates answer contents including the advertisement selected. This domain history of the user U1 is, for example, a domain history generated by association of log data of the user U1 for the plural domains and is used to generate a prompt for generation of the answer to the question by the user U1. The prompt for generation of the answer for the user U1 in response to the question from the user U1 may thus be generated by the association of the log data on the plural domains. A domain may be selected from the plural domains according to, for example, a state of a user or a question sentence, even for the same user or question. Furthermore, for example, the generative AI selects an advertisement according to the generated answer to the question by the user U1 and generates answer contents including the advertisement selected. The generative AI thus generates answer contents including an advertisement selected according to at least one of the user information on the user U1 and the answer generated as the answer to the question by the user U1. Furthermore, the generative AI generates answer contents including, in a predetermined frame (a third frame), the answer generated as the answer to the question by the user U1 and including, in a first frame, an advertisement selected from candidates for advertisement. Furthermore, the generative AI generates answer contents including, in a first frame, an advertisement selected from candidates for advertisement, and including, in a second frame, an advertisement selected on the basis of predetermined information, such as a bid price.

The generative AI server 50 provides information output from the generative AI, to the information processing apparatus 100 (Step S105). For example, the generative AI server 50 provides answer contents generated by the generative AI. Upon acquisition of the answer contents from the generative AI server 50, the information processing apparatus 100 provides the answer contents to the terminal device 10 (Step S106). Upon receipt of the answer contents from the information processing apparatus 100, the terminal device 10 causes the answer contents to be displayed.

The user U1 operating (for example, clicking or tapping on) the advertisement included in the answer contents displayed on the terminal device 10 generates a conversion. Upon generation of the conversion, the information processing apparatus 100 memorizes for which advertiser and which advertisement the conversion has been generated. The information processing apparatus 100 then determines cost the advertiser is to be charged, according to the number of conversions counted in a predetermined time period (Step S107). For example, the information processing apparatus 100 determines the cost the advertiser is to be charged, such that the larger the number of conversions is, the higher the cost becomes. The information processing apparatus 100 then charges the advertiser for the cost determined. Without being limited to the case where the information processing apparatus 100 charges the advertiser for the cost determined by counting of the number of conversions, the information processing apparatus 100 may charge the advertiser every time a conversion is made.

In the above described embodiment, the information processing apparatus 100 may determine cost for use of the generative AI, according to a volume of text of a question received from the user U1. For example, the information processing apparatus 100 may determine the cost for the use of the generative AI such that the larger the volume is, the higher the cost becomes. The information processing apparatus 100 may then perform processing for paying the cost determined to the provider of the generative AI. The cost for the use of the generative AI may be determined at any time, and may be determined, for example, at Step S101. Furthermore, the information processing apparatus 100 may determine the cost for the use of the generative AI, according to a volume of text of questions received from the user U1 in a predetermined time period. Determining the cost for the use of the generative AI and charging the advertiser according to the conversions enable services to be provided to the user U1 free of charge.

In the above described embodiment, the information processing apparatus 100 determines the cost for the use of the generative AI according to the volume of the text of the question, but in a case where the user U1 asks a further question in response to the answer included in the answer contents provided to the user U1, processing for payment of cost for use of the generative AI may be not performed for the further question in response to the answer. That is, the information processing apparatus 100 may determine the cost for the use of the generative AI, only for the first question. Furthermore, the answer to be included in the answer contents is generated on the basis of the prompt. Therefore, the prompt may be a prompt to instruct generation of an answer not resulting in a further question being asked in response to the answer, and the information processing apparatus 100 may generate such a prompt and provide information related to this prompt. Furthermore, the prompt may be a prompt to instruct generation of an answer prompting a conversion, for example, and the information processing apparatus 100 may generate such a prompt and provide information related to this prompt. Furthermore, the prompt may be a prompt generated on the basis of a history of any domain frequently used by the user U1, the history being from the domain history of the user U1, for example, and the information processing apparatus 100 may generate such a prompt and provide information related to this prompt. Furthermore, the prompt may be a prompt generated on the basis of a history selected according to the question of the user U1, the history being from the domain history of the user U1, for example, and the information processing apparatus 100 may generate such a prompt and provide information related to this prompt. Furthermore, the prompt may be a prompt to instruct the amount of advertising in the first frame to be changed according to a length of exchange of questions and answers between the user U1 and the generative AI, for example, and the information processing apparatus 100 may generate such a prompt and provide information related to this prompt. Furthermore, the prompt may be a prompt generated to have text shorter in length on the basis of a history selected according to the user U1, for example, and the information processing apparatus 100 may generate such a prompt and provide information related to this prompt.

With respect to the above described embodiment, the case where the information processing apparatus 100 determines the cost the advertiser is to be charged and charges the advertiser has been described as an example, but the information processing apparatus 100 may determine cost an advertising agency is to be charged, the advertising agency having a predetermined relation with the advertiser, and charge the advertising agency. In the above described embodiment, the information processing apparatus 100 determines the cost according to the conversions but the cost the advertising agency is to be charged may be determined according to the number of customers attracted. That is, the cost the advertising agency is to be charged may be determined according to the number of customers attracted to the advertising agency. The advertising agency may be in predetermined relations with plural advertisers.

With respect to the above described embodiment, the case where the generative AI selects an advertisement from the candidates for advertisement to generate the answer contents has been described as an example, but the generative AI may generate information related to conditions for listing advertisements by use of the candidates for advertisement. The information processing apparatus 100 may then acquire the information related to the conditions for the listing from the generative AI server 50 and generate answer contents by performing the listing.

### 3. Configuration of Terminal Device

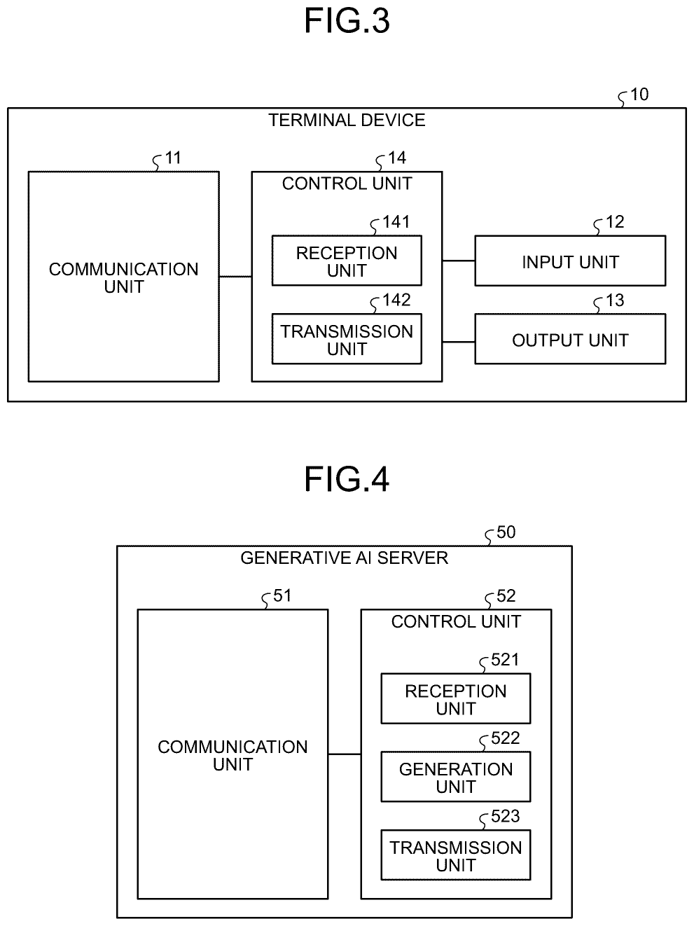

A configuration of the terminal device 10 according to the embodiment will be described next by use of FIG. 3. FIG. 3 is a diagram illustrating an example of the configuration of the terminal device 10 according to the embodiment. As illustrated in FIG. 3, the terminal device 10 has a communication unit 11, an input unit 12, an output unit 13, and a control unit 14.

### Communication Unit 11

The communication unit 11 is implemented by, for example, a network interface card (NIC). The communication unit 11 is connected to the predetermined network N by wire or wirelessly, and transmits and acquires information to and from the information processing apparatus 100, for example.

### Input Unit 12

The input unit 12 receives various kinds of operation from a user. In FIG. 2, the input unit 12 receives various kinds of operation from the user U1. For example, the input unit 12 may receive the various kinds of operation from the user via a display screen by means of a touch panel function. Furthermore, the input unit 12 may receive the various kinds of operation from buttons provided on the terminal device 10 or a keyboard or a mouse connected to the terminal device 10. For example, the input unit 12 receives text operation for input of a question.

### Output Unit 13

The output unit 13 is a display device that is a display screen, such as a tablet device implemented by, for example, a liquid crystal display or an organic electro-luminescence display, and that is for displaying various kinds of information. For example, the output unit 13 displays answer contents provided from the information processing apparatus 100.

### Control Unit 14

The control unit 14 is, for example, a controller, and is implemented by various programs being executed by a processing unit, such as a central processing unit (CPU) or a microprocessing unit (MPU), with a random access memory serving as a work area, the various programs having been stored in a storage inside the terminal device 10. For example, these various programs include an application program installed on the terminal device 10. For example, these various programs include an application program that causes display of answer contents provided from the information processing apparatus 100. Furthermore, the control unit 14 is implemented by an integrated circuit, such as, for example, an application specific integrated circuit (ASIC) or a field programmable gate array (FPGA).

As illustrated in FIG. 3, the control unit 14 has a reception unit 141 and a transmission unit 142, and implements or executes information processing described hereinafter.

### Reception Unit 141

The reception unit 141 receives, for example, answer contents provided from the information processing apparatus 100. For example, the reception unit 141 receives answer contents including an answer generated by the generative AI as an answer to a question from a user. Furthermore, for example, the reception unit 141 receives answer contents including an advertisement selected, by the generative AI, as an advertisement to be provided to a user.

### Transmission Unit 142

The transmission unit 142 transmits text information on a question input by a user, to the information processing apparatus 100, for example. For example, the transmission unit 142 transmits text information on a question input on a UI screen for a user to ask a question first. Furthermore, for example, the transmission unit 142 transmits text information on a question input on the UI screen for the user to ask a further question in response to answer contents provided. The transmission unit 142 may transmit user information on a user who has asked a question.

### 4. Configuration of Generative AI Server

A configuration of the generative AI server 50 according to the embodiment will be described next by use of FIG. 4. FIG. 4 is a diagram illustrating an example of the configuration of the generative AI server 50 according to the embodiment. As illustrated in FIG. 4, the generative AI server 50 has a communication unit 51 and a control unit 52. The generative AI server 50 may have input units (for example, a keyboard and a mouse) to receive various kinds of operation from the administrator of the generative AI server 50, and a display unit (for example, a liquid crystal display) for displaying various kinds of information.

### Communication Unit 51

The communication unit 51 is implemented by, for example, an NIC. The communication unit 51 is connected to the network N by wire or wirelessly, and transmits and acquires information to and from the information processing apparatus 100, for example.

### Control Unit 52

The control unit 52 is a controller, and is implemented by various programs being executed by a CPU or an MPU, for example, with a RAM serving as a work area, the various programs having been stored in a storage in the generative AI server 50. Furthermore, the control unit 52 is implemented by, for example, an integrated circuit, such as an ASIC or FPGA.

As illustrated in FIG. 4, the control unit 52 has a reception unit 521, a generation unit 522, and a transmission unit 523, and implements or executes information processing described hereinafter. The internal configuration of the control unit 52 is not limited to the configuration illustrated in FIG. 4, and may be any other configuration as long as the control unit 52 is configured to execute the later described information processing.

### Reception Unit 521

The reception unit 521 receives, for example, information provided from the information processing apparatus 100. For example, the reception unit 521 receives text information on a question input by a user. Furthermore, for example, the reception unit 521 receives advertisement candidate information for selecting an advertisement to be provided to the user (the user who has asked the question). Furthermore, for example, the reception unit 521 receives user information on the user (the user who has asked the question). Furthermore, for example, the reception unit 521 receives prompt information generated by the information processing apparatus 100. The reception unit 521 thus receives, for example, the text information on the question, the advertisement candidate information, the user information, and the prompt information. All of these pieces of information are input to the generative AI.

### Generation Unit 522

The generation unit 522 generates, for example, answer contents by inputting information provided from the information processing apparatus 100, to the generative AI. For example, the generation unit 522 generates an answer to be included in the answer contents. For example, the generation unit 522 generates an answer output from the generative AI as the answer to be included in the answer contents. Furthermore, for example, the generation unit 522 selects an advertisement to be included in the answer contents. For example, the generation unit 522 selects an advertisement output from the generative AI as the advertisement to be included in the answer contents. For example, the generation unit 522 selects an advertisement output from the generative AI as an advertisement to be included in a first frame of the answer contents. For example, the generation unit 522 may generate answer contents including the advertisement output from the generative AI in the first frame and including, in a second frame, an advertisement selected on the basis of predetermined information, such as a bid price.

### Transmission Unit 523

The transmission unit 523 provides, for example, answer contents generated by the generation unit 522, to the information processing apparatus 100. For example, the transmission unit 523 provides information output from the generative AI. For example, the transmission unit 523 provides information related to an answer output from the generative AI or information related to an advertisement output from the generative AI.

### 5. Configuration of Information Processing Apparatus

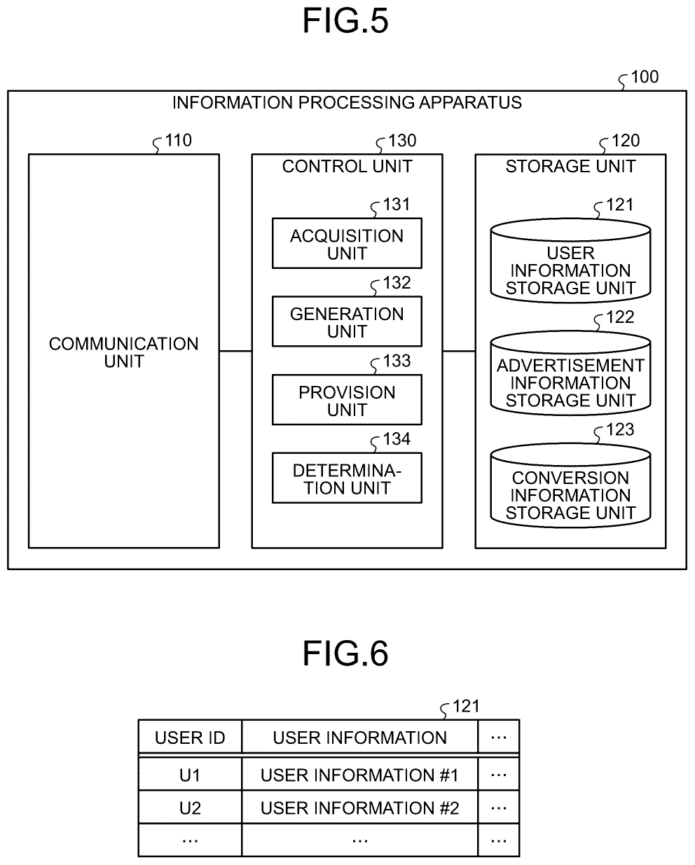

A configuration of the information processing apparatus 100 according to the embodiment will be described next by use of FIG. 5. FIG. 5 is a diagram illustrating an example of the configuration of the information processing apparatus 100 according to the embodiment. As illustrated in FIG. 5, the information processing apparatus 100 has a communication unit 110, a storage unit 120, and a control unit 130. The information processing apparatus 100 may have an input unit (for example, a keyboard or a mouse) to receive various kinds of operation from an administrator of the information processing apparatus 100 and a display unit (for example, a liquid crystal display) for displaying various kinds of information.

### Communication Unit 110

The communication unit 110 is implemented by, for example, an NIC. The communication unit 110 is connected to the network N by wire or wirelessly, and transmits and acquires information to and from the terminal device 10 and the generative AI server 50, for example.

### Storage Unit 120

The storage unit 120 is implemented by, for example, a semiconductor memory element, such as a RAM or a flash memory, or a storage such as a hard disk or an optical disk. As illustrated in FIG. 5, the storage unit 120 has a user information storage unit 121, an advertisement information storage unit 122, and a conversion information storage unit 123.

The user information storage unit 121 stores user information. For example, the user information storage unit 121 stores information indicating attributes, interests and tastes, and behavior histories, of users. FIG. 6 illustrates an example of the user information storage unit 121 according to the embodiment. The information stored in the user information storage unit 121 is used, for example, for generating answer contents. As illustrated in FIG. 6, the user information storage unit 121 has items, such as “user ID” and “user information”.

“User ID” represents identification information for identifying the users. “User information” represents user information. FIG. 6 illustrates an example where conceptual information, such as “user information #1” and “user information #2”, is stored as “user information”, but information indicating the attributes, such as ages, sexes, and places of residence of the users, information indicating the interests and tastes, and information indicating the behavior histories, are actually stored, for example.

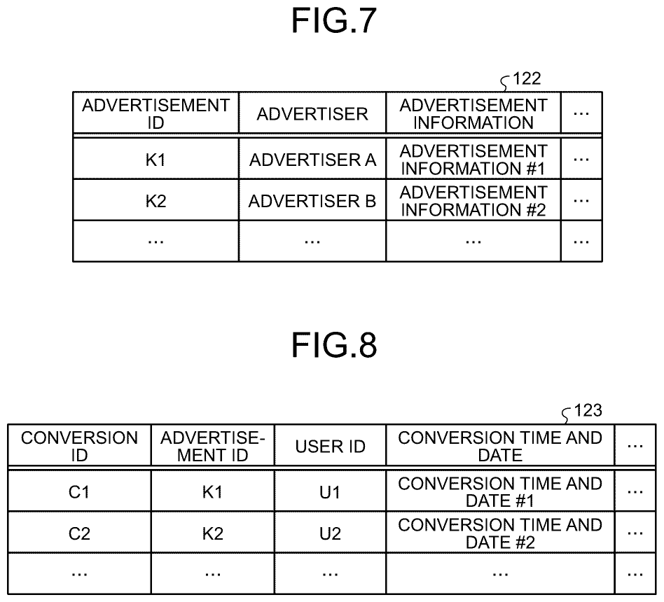

The advertisement information storage unit 122 stores advertisement information. For example, the advertisement information storage unit 122 stores information indicating advertisers, categories of advertisements, and target users, and image data on the advertisements. Information stored in the advertisement information storage unit 122 is used, for example, for generating answer contents. FIG. 7 illustrates an example of the advertisement information storage unit 122 according to the embodiment. As illustrated in FIG. 7, the advertisement information storage unit 122 has items, such as “advertisement ID”, “advertiser”, and “advertisement information”.

“Advertisement ID” represents identification information for identifying the advertisements. “Advertiser” represents the advertisers. “Advertisement information” represents advertisement information. FIG. 7 illustrates an example where conceptual information, such as “advertisement information #1” and “advertisement information #2”, is stored as “advertisement information”, but image data are actually stored, for example. Furthermore, URLs where the image data are located or file pass names indicating their storage locations may be stored, for example.

The conversion information storage unit 123 stores conversion information. For example, the conversion information storage unit 123 stores information indicating users who have made conversions and advertisements the conversions have been made for. Information stored in the conversion information storage unit 123 is used for, for example, counting the numbers of conversions or determining cost the advertisers are to be charged. FIG. 8 illustrates an example of the conversion information storage unit 123 according to the embodiment. As illustrated in FIG. 8, the conversion information storage unit 123 has items, such as “conversion ID”, “advertisement ID”, “user ID”, and “conversion time and date”.

“Conversion ID” represents identification information for identifying the conversions. “Advertisement ID” represents identification information for identifying the advertisements. “User ID” represents identification information for identifying the users. “Conversion time and date” represents time and dates of the conversions. FIG. 8 illustrates an example where conceptual information, such as “conversion time and date #1” and “conversion time and date #2”, is stored as “conversion time and date”, but information indicating the time and dates is actually stored.

### Control Unit 130

The control unit 130 is a controller, and is implemented by various programs being executed by a CPU or an MPU, for example, with a RAM serving as a work area, the various programs having been stored in a storage in the information processing apparatus 100. Furthermore, the control unit 130 is implemented by, for example, an integrated circuit, such as an ASIC or FPGA.

As illustrated in FIG. 5, the control unit 130 has an acquisition unit 131, a generation unit 132, a provision unit 133, and a determination unit 134, and implements or executes information processing described hereinafter. The internal configuration of the control unit 130 is not limited to the configuration illustrated in FIG. 5, and may be any other configuration that performs the information processing described later.

### Acquisition Unit 131

The acquisition unit 131 acquires various kinds of information from the storage unit 120. Furthermore, the acquisition unit 131 stores the various kinds of information acquired, into the storage unit 120.

The acquisition unit 131 acquires various kinds of information from an external information processing apparatus. The acquisition unit 131 acquires various kinds of information from another information processing device, such as the terminal device 10.

The acquisition unit 131 receives a question from a user by acquiring text information on the question input by the user, for example. For example, the acquisition unit 131 receives the first question from a user by acquiring text information on the question input by the user on a UI screen for the user to ask the first question. Furthermore, for example, the acquisition unit 131 receives a further question from the user by acquiring text information on the question input by the user on a UI screen for the user to ask the further question in response to answer contents. Furthermore, in a case where a conversion has been generated by the user operating an advertisement included in the answer contents, for example, the acquisition unit 131 acquires information related to the conversion generated.

The acquisition unit 131 acquires, for example, a user history. For example, the acquisition unit 131 acquires a user history for plural domains. For example, the acquisition unit 131 acquires a user history for plural domains as user information.

### Generation Unit 132

Upon receipt of a question from a user (upon acquisition of text information on the question) by the acquisition unit 131, for example, the generation unit 132 causes the generative AI to generate answer contents by causing candidates for advertisement, the question (the text information on the question), user information, and prompt information to be input to the generative AI. For example, by providing advertisement candidate information, a question sentence, user information, and prompt information to the generative AI server 50, the generation unit 132 causes them to be input to the generative AI and causes answer contents to be generated. For example, the generation unit 132 causes an answer to be generated, the answer being an answer to be included in the answer contents to be provided to the user who has asked the question. Furthermore, for example, the generation unit 132 causes an advertisement to be selected from candidates for advertisement, the advertisement being an advertisement to be included in the answer contents to be provided to the user who has asked the question. Furthermore, the generation unit 132 causes the answer contents generated by the generative AI to be provided to the information processing apparatus 100, for example.

### Provision Unit 133

The provision unit 133 provides answer contents the generative AI was caused to generate, to a user by, for example, providing the answer contents to the terminal device 10. For example, the provision unit 133 provides information related to an answer the generative AI was caused to generate. For example, the provision unit 133 provides answer contents including an answer the generative AI was caused to generate. For example, the provision unit 133 provides answer contents generated on the basis of information related to an answer the generative AI was caused to generate. For example, the provision unit 133 provides answer contents generated on the basis of information related to an answer acquired through acquisition of information related to the answer from the generative AI server 50. Furthermore, for example, the provision unit 133 provides information related to an advertisement the generative AI was caused to select. For example, the provision unit 133 provides answer contents including an advertisement the generative AI was caused to select. For example, the provision unit 133 provides answer contents generated on the basis of information related to an advertisement the generative AI was caused to select. For example, the provision unit 133 provides answer contents generated on the basis of information related to an advertisement acquired through acquisition of information related to the advertisement from the generative AI server 50.

The provision unit 133 provides, for example, a user history acquired by the acquisition unit 131, to the generative AI server 50. For example, the provision unit 133 provides, as user information, a history satisfying a predetermined condition, the history being from the user history acquired by the acquisition unit 131. For example, the provision unit 133 provides, as user information, a history corresponding to a question by a user, the history being from the user history acquired by the acquisition unit 131. The history satisfying the predetermined condition is, for example, a history selected as a history to be input to the generative AI. Furthermore, the history satisfying the predetermined condition is, for example, a history selected as a history for causing the generative AI to generate answer contents. Furthermore, the history satisfying the predetermined condition is, for example, a history selected as a history for causing the generative AI to generate answer contents including an answer to a question. Furthermore, the history satisfying the predetermined condition is, for example, a history selected as a history for causing the generative AI to generate answer contents including an advertisement for conversions. Furthermore, the history satisfying the predetermined condition is, for example, a history selected as a history for causing the generative AI to generate answer contents including a predetermined advertisement in a first frame and including, in a second frame, an advertisement selected on the basis of a bid price from candidates for advertisement.

### Determination Unit 134

The determination unit 134 determines cost an advertiser is to be charged, according to operation by a user on an advertisement included in answer contents provided by the provision unit 133, for example. For example, the determination unit 134 determines cost an advertiser is to be charged, according to the number of conversions corresponding to operation by a user on an advertisement included in answer contents. The determination unit 134 then charges the advertiser for the cost determined in this way, for example. Furthermore, the determination unit 134 determines cost for use of the generative AI according to a volume of text represented by text information acquired by the acquisition unit 131, for example. The determination unit 134 may then perform processing for making a payment to the provider of the generative AI for the cost determined in this way, for example.

### 6. Flow of Information Processing

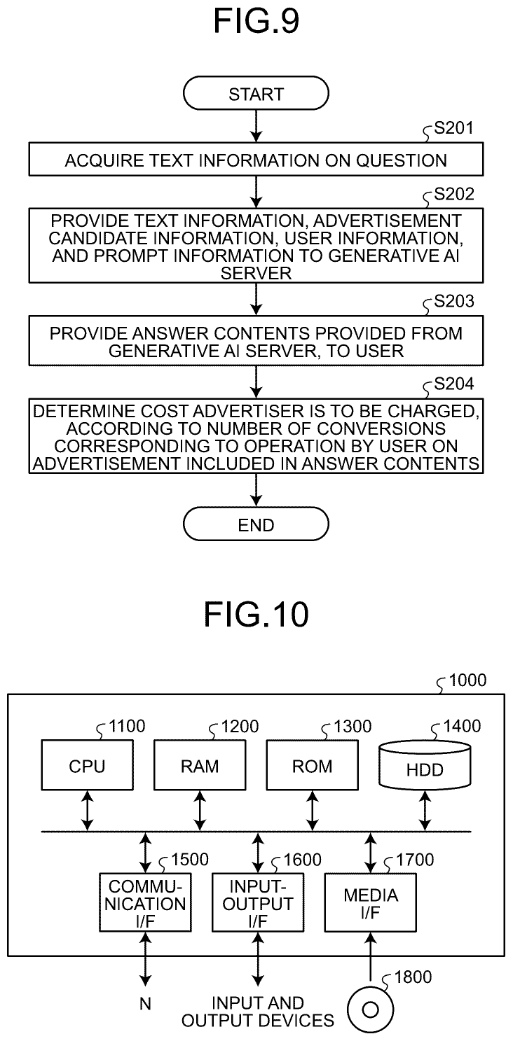

A procedure of information processing by the information processing system 1 according to the embodiment will be described next by use of FIG. 9. FIG. 9 is a flowchart illustrating the procedure of the information processing by the information processing system 1 according to the embodiment.

As illustrated in FIG. 9, the information processing apparatus 100 acquires text information on a question input by a user (Step S201).

By providing the text information acquired, advertisement candidate information, user information, and prompt information to the generative AI server 50, the information processing apparatus 100 causes them to be input to the generative AI and answer contents to be generated by the generative AI (Step S202).

The information processing apparatus 100 provides the answer contents that the generative AI was caused to generate (that is, the answer contents provided from the generative AI server 50), to the user (Step S203).

The information processing apparatus 100 determines cost that an advertiser is to be charged, according to the number of conversions corresponding to operation by the user on an advertisement included in the answer contents provided (Step S204).

### 7. Effects

As described above, the information processing apparatus 100 according to the embodiment has the generation unit 132, the provision unit 133, and the determination unit 134. Upon receipt of a question from a user, the generation unit 132 causes candidates for advertisement and the question to be input to the generative AI and thereby causes the generative AI to generate answer contents including an advertisement selected from the candidates according to at least one of the user and an answer generated by the generative AI as an answer to the question. The provision unit 133 provides the answer contents that the generative AI was caused to generate by the generation unit 132, to the user. The determination unit 134 determines cost an advertiser of the advertisement is to be charged, according to operation by the user on the advertisement.

The information processing apparatus 100 according to the embodiment thereby enables charging according to conversions via the answer contents, for example, and thus enables well-suited monetization using the generative AI.

Furthermore, the determination unit 134 determines cost for use of the generative AI according to a volume of text of the question.

The information processing apparatus 100 according to the embodiment thereby enables well-suited monetization according to the volume of the text of the question, for example.

Furthermore, the determination unit 134 determines the cost the advertiser is to be charged, according to the number of conversions for the advertisement.

The information processing apparatus 100 according to the embodiment thereby enables well-suited monetization according to the number of conversions, for example.

Furthermore, the generation unit 132 causes the answer contents to be generated, the answer contents including the advertisement in a first frame and including, in a second frame, an advertisement selected from the candidates on the basis of a bid price.

The information processing apparatus 100 according to the embodiment thereby enables provision of an advertisement of a product that the user may want, together with an advertisement of a product based on a bid price, for example.

Furthermore, the generation unit 132 causes the answer contents to be generated, the answer contents including an answer generated by causing a prompt to be input to the generative AI, the prompt being a prompt to instruct generation of an answer not resulting in a further question being asked in response to the answer.

The information processing apparatus 100 according to the embodiment thereby enables a load on the information processing apparatus 100 to be reduced, the load being due to a service provided by the information processing apparatus 100, for example.

Furthermore, the generation unit 132 causes the answer contents to be generated, the answer contents including an answer generated by causing a prompt to be input to the generative AI, the prompt being a prompt generated to have text shorter in length on the basis of a history selected according to the user.

The information processing apparatus 100 according to the embodiment thereby enables a load on the information processing apparatus 100 to be reduced, the load being due to a service provided by the information processing apparatus 100, for example.

### 8. Hardware Configuration

The above described information processing apparatus 100 according to the embodiment is implemented by, for example, a computer 1000 having a configuration illustrated in FIG. 10. FIG. 10 is a hardware configuration diagram illustrating an example of a computer that implements functions of the information processing apparatus 100. The computer 1000 has a CPU 1100, a RAM 1200, a ROM 1300, an HDD 1400, a communication interface (I/F) 1500, an input-output interface (I/F) 1600, and a media interface (I/F) 1700.

The CPU 1100 operates on the basis of programs stored in the ROM 1300 or the HDD 1400 and controls each unit. The ROM 1300 stores a boot program executed by the CPU 1100 when the computer 1000 is booted, and a program dependent on hardware of the computer 1000, for example.

The HDD 1400 stores a program executed by the CPU 1100 and data used by the program, for example. The communication interface 1500 acquires data from another device via a predetermined communication network and sends the data to the CPU 1100, and transmits data generated by the CPU 1100 to another device via a predetermined communication network.

The CPU 1100 controls, via the input-output interface 1600, output devices, such as a display and a printer, and input devices, such as a keyboard and a mouse. The CPU 1100 acquires data from the input devices via the input-output interface 1600. Furthermore, the CPU 1100 outputs data generated, to the output devices via the input-output interface 1600.

The media interface 1700 reads a program or data stored in a recording medium 1800 and provides the program or data read, to the CPU 1100 via the RAM 1200. The CPU 1100 loads the program into the RAM 1200 from the recording medium 1800 via the media interface 1700 and executes the program loaded. The recording medium 1800 is, for example: an optical recording medium, such as a digital versatile disc (DVD) or a phase change rewritable disk (PD); a magneto-optical recording medium, such as a magneto-optical (MO) disk; a tape medium; a magnetic recording medium; or a semiconductor memory.

For example, in a case where the computer 1000 functions as the information processing apparatus 100 according to the embodiment, the CPU 1100 of the computer 1000 implements functions of the control unit 130 by executing a program loaded into the RAM 1200. The CPU 1100 of the computer 1000 reads and executes such programs from the recording medium 1800, but in another example, the CPU 1100 may acquire these programs from another apparatus via a predetermined communication network.

### 9. Others

Of the processing described above with respect to the embodiment, all or a part of any processing described as being performed automatically may be performed manually, or all or a part of any processing described as being performed manually may be performed automatically by a publicly known method. In addition, the processing procedures, the specific names, and the information including the various data and parameters described above and illustrated in the drawings may be modified in any way unless otherwise particularly stated. For example, the various kinds of information illustrated in the drawings are not limited to the information illustrated therein.

Furthermore, the components of each apparatus/device in the drawings have been illustrated functionally and/or conceptually, and are not necessarily physically configured as illustrated in the drawings. That is, specific modes of separation and integration of each apparatus/device are not limited to those illustrated in the drawings, and all or part of each apparatus/device may be configured to be separated or integrated functionally or physically in any units according to various loads and use situations.

Furthermore, the embodiments described above may be combined, as appropriate, so long as no contradictions arise in the processing from the combination.

Some of embodiments of the present application have been described in detail above on the basis of the drawings, but these are just examples, and the present invention may be implemented in other modes that have been modified or improved in various ways on the basis of the modes described in the section, Detailed Description of the Preferred Embodiments, and knowledge of those skilled in the art.

Furthermore, any “unit, section, or module” mentioned above may be read as “means” or “circuit”. For example, an acquisition unit may be read as an acquisition means or an acquisition circuit.

An embodiment in one aspect has an effect of enabling well-suited monetization using generative AI.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus, including:
a generation unit that causes generative AI to generate answer contents including an advertisement selected from candidates for advertisement according to at least one of a user and an answer that has been generated by the generative AI as an answer to a question by inputting the candidates and the question to the generative AI upon receipt of the question from the user;
a provision unit that provides the answer contents that the generative AI was caused to generate by the generation unit, to the user; and
a determination unit that determines cost that an advertiser of the advertisement is to be charged, according to operation on the advertisement by the user.

2. The information processing apparatus according to claim 1, wherein the determination unit determines cost for use of the generative AI, according to a volume of text of the question.

3. The information processing apparatus according to claim 1, wherein the determination unit determines the cost the advertiser is to be charged, according to the number of conversions for the advertisement.

4. The information processing apparatus according to claim 1, wherein the answer contents caused by the generation unit to be generated include the advertisement in a first frame and include, in a second frame, an advertisement selected from the candidates on the basis of a bid price.

5. The information processing apparatus according to claim 1, wherein the answer contents caused by the generation unit to be generated include an answer generated by input of a prompt to the generative AI, the prompt instructing generation of an answer not resulting in a further question being asked in response to the answer.

6. The information processing apparatus according to claim 1, wherein the answer contents caused by the generation unit to be generated include an answer generated by input of a prompt to the generative AI, the prompt having been generated to have text shorter in length on the basis of a history selected according to the user.

7. An information processing method executed by a computer and including:
a generation step of causing generative AI to generate answer contents including an advertisement selected from candidates for advertisement according to at least one of a user and an answer that has been generated by the generative AI as an answer to a question by inputting the candidates and the question to the generative AI upon receipt of the question from the user;
a provision step of providing the answer contents that the generative AI was caused to generate through the generation step, to the user; and
a determination step of determining cost that an advertiser of the advertisement is to be charged, according to operation on the advertisement by the user.

8. A non-transitory computer readable storage medium having stored an information processing program that causes a computer to execute:
a generation process of causing generative AI to generate answer contents including an advertisement selected from candidates for advertisement according to at least one of a user and an answer that has been generated by the generative AI as an answer to a question by inputting the candidates and the question to the generative AI upon receipt of the question from the user;
a provision process of providing the answer contents that the generative AI was caused to generate through the generation process, to the user; and
a determination process of determining cost that an advertiser of the advertisement is to be charged, according to operation on the advertisement by the user.
